(19) United States
(12) Patent Application Publication
(10) Pub. No.: US 2018/0017949 A1
(43) Pub. Date: Jan. 18, 2018

(54) AUDIO, VIDEO AND LIGHT CONTROL SYSTEM ENCAPSULATED IN A SINGLE HOUSING

(71) Applicant: GIVA AUDIOVISUAL TECHNOLOGIES BVBA, Paal (BE)

(72) Inventors: Paul VAN HEES, Mol (BE); Hendrik-Jan GIELIS, Beringen (BE)

(73) Assignee: GIVA AUDIOVISUAL TECHNOLOGIES BVBA, Paal (BE)

(21) Appl. No.: 15/544,043

(22) PCT Filed: Jan. 8, 2016
(86) PCT No.: PCT/EP2016/050309

§ 371 Date: Jul. 17, 2017

(30) Foreign Application Priority Data
Jan. 16, 2015 (EP) 15151420.5
Apr. 10, 2015 (EP) 15163268.4

(51) Int. Cl. G05B 15/02; G06F 3/0488

(52) U.S. Cl. CPC G05B 15/02; G06F 3/04883

(57) ABSTRACT

The invention provides for a system (capable of)/for controlling a plurality of (audio, visual and/or mechanical and/or lighting) devices in a location, the system comprising/consisting (1) a housing comprising an electronic subsystem (controller) for generating (all) control signals for (all) said devices and input/output connectors for providing the generated control signals to said devices; and (2) a touchscreen console (being in communication with said electronic subsystem), (solely) used (and hence not for receiving other visual info) for (and being the sole physical way for) (hence no additional buttons being present, in an embodiment a further external web browser access is provided) steering the operations of said electronic subsystem; whereby said touchscreen console, being provided on said housing.

### FIELD OF THE INVENTION

The invention relates to the field of audio, video and/or light control systems, computer programs and graphical user interfaces related thereto.

### BACKGROUND OF THE INVENTION

In the field of audio/visual support systems, typically huge systems, comprising a plurality of racks (separate housings), each providing a dedicated function (audio, visual and other) are used.

To improve the efficiency of use of those huge expensive systems, those systems can be used in a distributed manner, meaning a single system is used to support a plurality of locations, each location being equipped with a simple user console, wired or wireless communicating therewith. Further central at the location of the system a more elaborated (at least having more than the simple user console functionality) console for expert handling of the system is typically provided.

Of course also dedicated devices exist. Television equipment does provide typically for video in signals and audio out signals. An ordinary desk top computer does provide typically for video out signals (for the computer screen) and audio out signals. However those devices do not provide all the required functionalities.

### SUMMARY OF THE INVENTION

The invention on the contrary provides for a small audio/visual support system by providing a system, having all the required functions (hence a generic device), being encapsulated in a single housing.

The invented system does provide for video in and out signals and audio out and in signals (preferably at least a few being high quality stereo) and signals suitable for steering mechanical or lighting devices, such as DMX. Moreover in a preferred embodiment the system provides for sufficient storage space for storage of content (video, audio) not found in television sets.

Hence the invention provides for the use of a single system for a single location, wherein it supports at least the audio/visual demands, and more preferably also controls mechanical operations such as operating roller shutters of that particular location, steering motors to place a projector in the right position in the location or alternatively in addition to at least the audio demands preferably also controls light fixtures and/or use an output to be used for digital signage/advertising.

This deliberate single housing choice further enables (contrary to ordinary desktop computers) integration of the console on or in the housing, hence preferably the system also comprises a touchscreen on or in the housing, used as console. Moreover even more preferably the console can be used both as user and expert console (hence only one console is used for controlling the entire system).

The above dual demand on the console poses a challenge in particular on the software (GUI) supporting it, in that a first view, suited for (unexperienced) user control must be provided, while going to a more elaborated view, suited for more expert control, must be made available also when necessary.

Preferably the first view is relatively easy with some preprogrammed scenario support buttons complemented with a few fixed sliders for audio and light control.

Preferably the second view has more detailed sliders for tuning separate (further) aspects of the audio and/or light control, even more preferably the second view gets generated by touching a predetermined portion of the provided fix sliders of the first view.

Obviously the dimensions of the entire system are limited in space (as it must also smoothly fit in the location that it supports) and consequently the integrated touchscreen also has to be limited in size, which has further technical consequences for the GUI layout. Therefore in a preferred embodiment, the more detailed sliders can, when activated, overlay or overlap with one or more elements (sliders, buttons) of the first view.

Finally it must be pointed out that while the system is integrated in one housing does not mean it is limited in functionality per se. Obviously the amount of connectors is adapted for the single location type of support aimed at but for instance in a preferred embodiment also directly connecting content carriers (like an USB stick) is provided.

In a further preferred embodiment one differentiates between those connectors which should be easily accessible for the users (like the HDMI and/or USB port) by placing those on the sidewall of the housing while all or substantially all the other connectors are placed on the side of the housing oriented downwards while the system is installed on its support (as those are actually relatively fixed connections with the external equipment in the space that the invented system supports the control of).

Again the above alternative uses for control of light fixtures and/or use an output to be used for digital signage/advertising on the console poses a challenge in particular on the software (GUI) supporting it as further detailed below.

One will appreciate that in a particular useful use of the system, the system is arranged in that the screen is arranged tilted under a predefined angle with respect to a virtual vertical plane and hence the housing is fixed on a support. Given that the amount of functionality leads to a relatively heavy weight and the necessary height (to accommodate the having of a reasonable screen dimension), one understand that yet another technical design challenge for stability must be tackled, in particular since also the size of the bottom part of the support is limited (given the targeted use). While the above boils down in ensuring that the vertical projection of the center of gravity of the entire system lies within the space defined by the bottom part, one must be aware that the design space is given the planar character of the board (equally tilted of course as it is in parallel with the front panel of the system) on which the electronics are mounted. Note that the requirement of stability is mandatory for the tilted use case. In an embodiment of the invention one deviates from a strict rectangular housing and/or strict planar organization of all electronic components, in that the lower part of the housing (the portion directed to the bottom part of the support) is substantial thicker than the upper part and/or one or more of the electronic components are mounted in parallel planes (e.g. one connector is placed above a connector fixed on the board) and preferably the thicker part of the housing is used only around those portions where electronic components are arranged as described above). All this ensures more mass in the lower part and contributes to better stability. Note that while the amount of functionality which is reflected in the amount of different connectors would lead in a straightforward design to a linear positioning of all those connectors, again the smallness requirement puts limitations thereto. Further an at random other positioning of those connectors complicated the electronic design and may result in mechanical stability issues. The choice for a rather or more or less symmetric design of the connector layout when viewed along the width of the housing in combination with a centralized thickening of the housing allowing stacking of a few connectors and/or having connectors with at least two rows of input and/or output is hence a deliberate choice with synergic effects in several of the design challenges for this system. FIG. 5 shows an exemplary layout of the connectors while FIG. 6 shows the 3D corresponding shape of the housing.

Given the amount of functionality (and even when taking into account the power consumption reduction techniques carefully selected in the system) still heat generated by the electronic components must be evaded from the internals of the system. In an embodiment of the invention the housing is provided with studs (e.g. made of alumina), connected to one or more of the electronic components (for instance the processor and/or the amplifier) to guide the heat externally.

One will further appreciate that the system has a plurality of quite different design requirements in various domains which mutually influence each other such as thermal design, electronic design (including interference), mechanical stability, functionality selection, hardware versus software design, user friendliness, especially in view of the touch screen the primary use for interacting.

Alternatively formulated one can state that one or more embodiments of the invention relate to an (electronic) system (capable of)/for controlling a plurality of (audio, visual (video) and/or mechanical and/or lighting) devices in a location, more in particular these devices are hence of a different nature in terms of input and/or output signals required. In a preferred embodiment the electronic system is adapted for controlling at least an audio device (at least generate speaker signals and optionally also able to capture microphone data), a visual device (at least generate video signal but optionally also received video signals) and one other than audio or visual (video) device, like a mechanical and/or lighting) device. Note that with electronic system is meant here in an embodiment of the invention the hardware platform of electronic components and the (PCB) board on which these are connected and the necessary soft- or firmware running on the programmable components.

The above described system comprises of a housing comprising an electronic subsystem for generating (all) signals (hence at least audio, video and signals suitable for steering mechanical or lighting devices, such as DMX) for (all) said devices and input/output connectors for providing the generated signals to said devices.

One will recognize that integrating of all such functionality requires special technical considerations as one likes to include as much as possible programmable and available components (instead of specific ASICs) while one must take into account that each of those functions have substantial different requirements.

In an embodiment of the invention the system comprises a general purpose processor system (such as an ARM platform, having an ARM processor and some storage means (e.g. for storage of content)), acting as central controller, and a digital signal processor (DSP) (under control of the general purpose processor), adapted for handling the (high quality) audio signals. Moreover further microcontrollers, capable of generating (under control of the general purpose processor) the synchronous signals required for steering mechanical or lighting devices, are foreseen. All these electronic components are integrated on one board. Preferably the general purpose processor system is capable of supporting the one or more wired or wireless communications. While the general purpose processor may execute video or multi-media programs and hence may input and/or output video signals, the high quality handling of incoming or outgoing video is further supported by a video switching component, again under control of the general purpose processor system.

### BRIEF DESCRIPTION OF THE DRAWINGS

FIG. 1 gives a schematic overview of the invented system (100).

FIG. 2 illustrates schematically the touchscreen (500).

FIG. 3 shows a side picture of an exemplary embodiment of the invention.

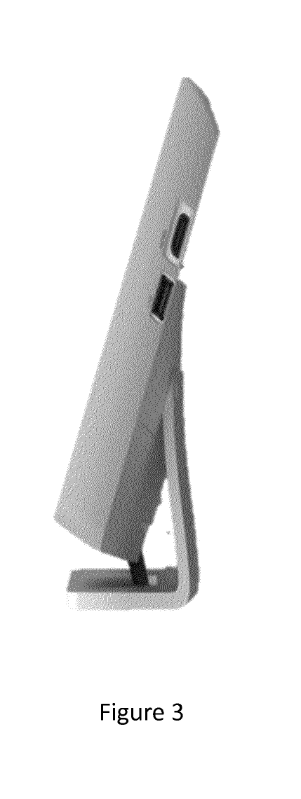

FIG. 4 shows a front picture of an exemplary embodiment of the invention.

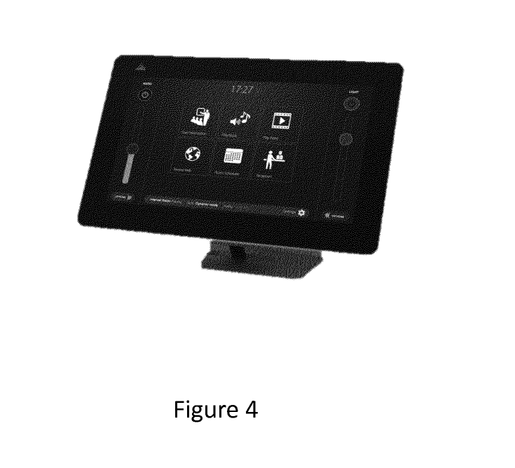

FIG. 5 shows the connector part on one side of the housing.

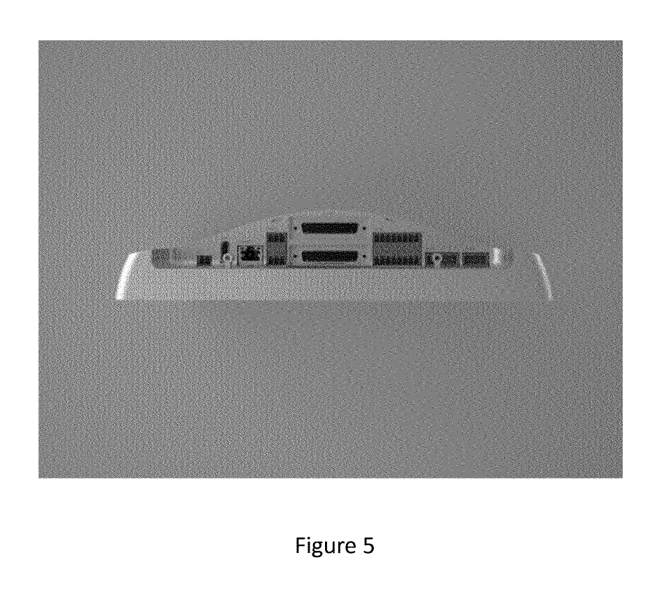

FIG. 6 shows the shape of the housing.

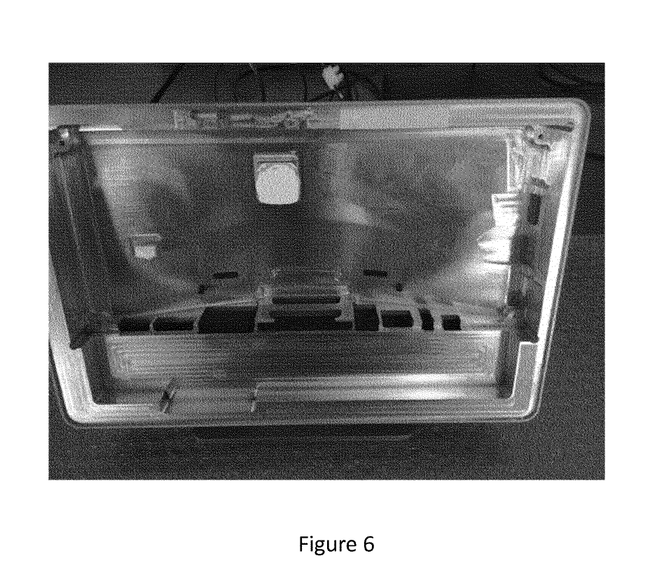

FIG. 7 gives a more detailed schematic overview of an embodiment of the invented system (100).

FIG. 8 gives an even more detailed schematic overview of an embodiment of the invented system (100).

### DETAILED DESCRIPTION

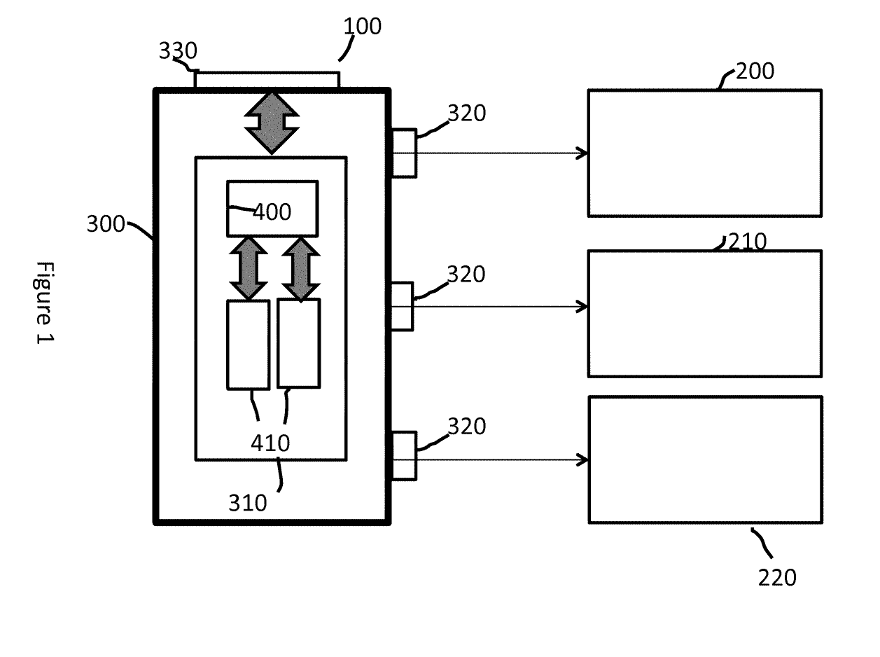

FIG. 1 gives a schematic overview of the invented system (100) adapted for controlling a plurality of (audio, visual and/or mechanical and/or lighting) devices (200, 210, 220, the system comprising (1) a housing (300) comprising an electronic subsystem (310) for generating (all) control signals for (all) said devices and input/output connectors (320) for providing the generated control signals to said devices; and (2) a touchscreen console (330) (being in communication with said electronic subsystem), used for steering the operations of said electronic subsystem; whereby said touchscreen console, being provided on said housing. In an embodiment the system comprises a processor system (400) and other electronic components (410), integrated on one board.

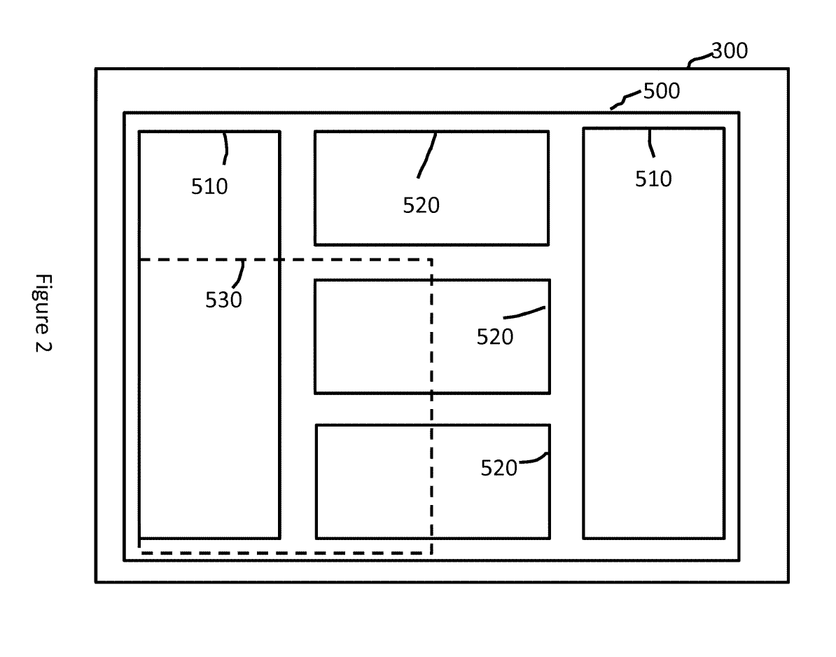

FIG. 2 illustrates the touchscreen (500) is configured (1) for providing a first display (here slides (510) and basis buttons (520)) dedicated for first (basic) users and (2) for providing on request a second display (here a combination of the first display with the component (530) dedicated for second (expert) users of one or more of said plurality of devices. wherein said second display (when activated) at least overlaps in part with parts of said first display. The size of the touchscreen fits with the size of a surface of the housing (300). Even in the context of the relatively small dimensions of the housing, the touchscreen with overlapping displays on demand can provide intelligent control facilities.

The invention on the contrary provides for a small audio/visual support system by providing a system, having all the required functions, being encapsulated in a single housing. Hence the invention provides for the use of a single system for a single location, wherein it supports the audio/visual demands, and more preferably also controls mechanical operations such as operating roller shutters of that particular location, steering motors to place a projector in the right position in the location.

This deliberate single housing choice further enables integration of the console on or in the housing, hence preferably the system also comprise a touchscreen on or in the housing, used as console. Moreover even more preferably the console can be used both as user and expert console (hence only one console is used for controlling the entire system).

The above dual demand on the console poses a challenge in particular on the software (GUI) supporting it, in that a first view, suited for (unexperienced) user control must be provided, while going to a more elaborated view, suited for more expert control, must be made available also when necessary.

Preferably the first view is relatively easy with some preprogrammed scenario support buttons complemented with a few fixed sliders for audio and light control.

Preferably the second view has more detailed sliders for tuning separate (further) aspects of the audio and/or light control, even more preferably the second view gets generated by touching a predetermined portion of the provided fix sliders of the first view.

Obviously the dimensions of the entire system are limited in space (as it must also smoothly fit in the location that it supports) and consequently the integrated touchscreen also has to be limited in size, which has further technical consequences for the GUI layout. Therefore in a preferred embodiment, the more detailed sliders can, when activated, overlay or overlap with one or more elements (sliders, buttons) of the first view.

Finally it must be pointed out that while the system is integrated in one housing does not mean it is limited in functionality per se. Obviously the amount of connectors is adapted for the single location type of support aimed at but for instance in a preferred embodiment also directly connecting content carriers (like an USB stick) is provided.

The invention relates to an (electronic) system (capable of)/for controlling a plurality of (audio, visual (video) and/or mechanical and/or lighting) devices in a location, more in particular these devices are hence of a different nature in terms of input and/or output signals required. In a preferred embodiment the electronic system is adapted for controlling at least an audio device (at least generate speaker signals and optionally also able to capture microphone data), a visual device (at least generate video signal but optionally also received video signals) and one other than audio or visual (video) device, like a mechanical and/or lighting) device. Note that with electronic system is meant here in an embodiment of the invention the hardware platform of electronic components and the (PCB) board on which these are connected and the necessary soft- or firmware running on the programmable components.

The above described system comprises of a housing comprising an electronic subsystem for generating (all) signals (hence at least audio, video and signals suitable for steering mechanical or lighting devices, such as DMX) for (all) said devices and input/output connectors for providing the generated signals to said devices.

In a preferred embodiment the system is further adapted for support Bluetooth, Wifi and/or IR (e.g. used for activating the video console used) wireless communication and to support wired network connectivity also.

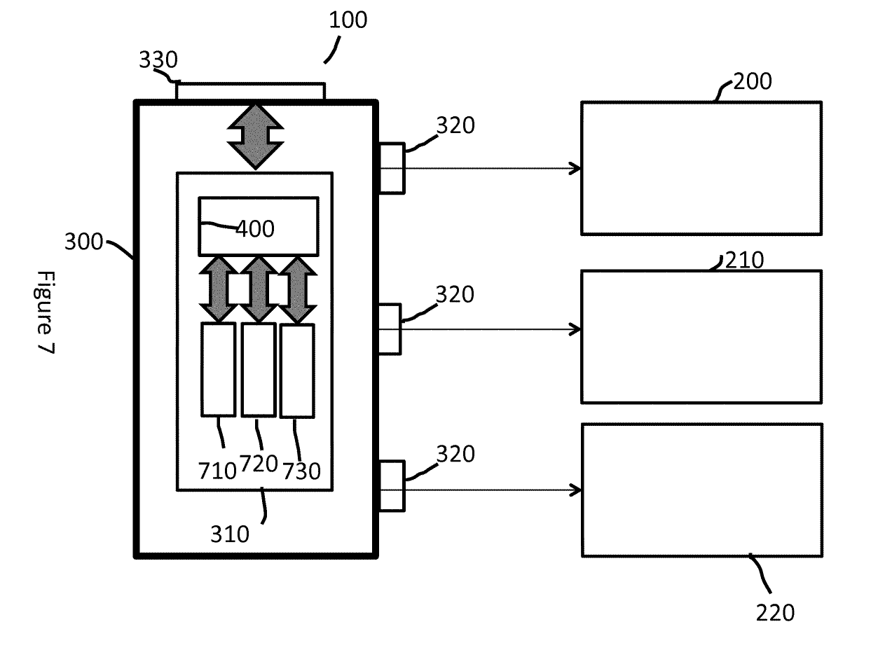

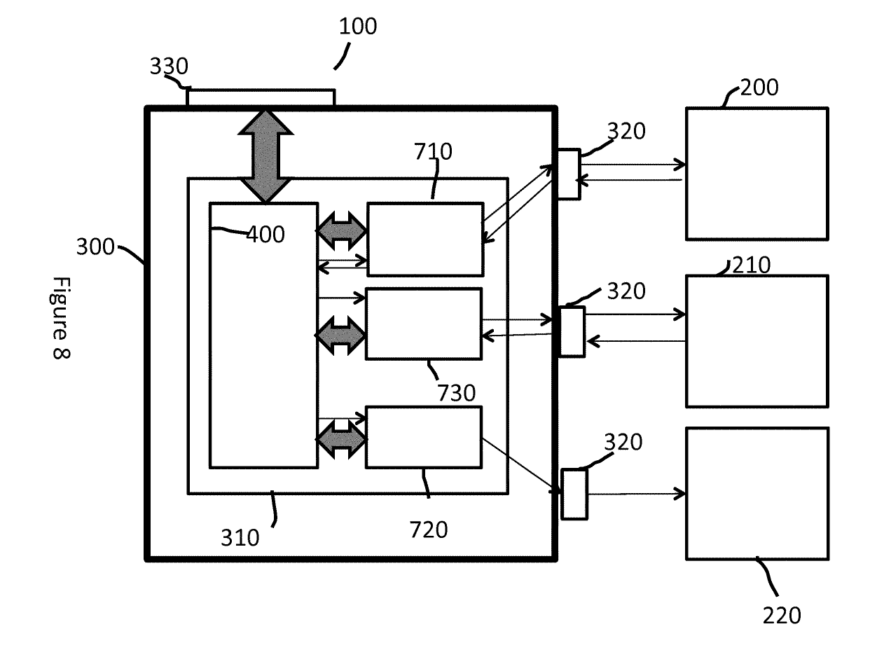

One will recognize that integrating of all such functionality requires special technical considerations as one likes to include as much as possible programmable and available components (instead of specific ASICs) while one must take into account that each of those functions have substantial different requirements. In an embodiment of the invention outlined in FIGS. 7 and 8 the system comprises a general purpose processor system (such as an ARM platform, having an ARM processor and some storage means (e.g. for storage of content)), acting as central controller, and a digital signal processor (DSP) (under control of the general purpose processor), adapted for handling the (high quality) audio signals. Moreover further microcontrollers, capable of generating (under control of the general purpose processor) the synchronous signals required for steering mechanical or lighting devices, are foreseen. All these electronic components are integrated on one board. Preferably the general purpose processor system is capable of supporting the one or more wired or wireless communications. While the general purpose processor may execute video or multi-media programs and hence may input and/or output video signals, the high quality handling of incoming or outgoing video is further supported by a video switching component, again under control of the general purpose processor system. Note that the big arrows between the components (710, 720, 730) and the processor (400) indicate control signals while the small arrows indicate mono or bi-directional data communication (audio, video, DMX).

In an embodiment of the invention the digital signal processor is capable of implementing an audio matrix functionality—hence every audio input can be routed to whatever audio output. Said functionality is realized via programming of the digital signal processing via the GUI.

Note that the asynchronous operations of the GPU (400) in combination with the synchronous signal demand of the elements (220) require a buffer functionality of the microcontrollers (720).

In an embodiment of the invention one of the control busses is an I2C bus and in particular such bus is chosen for communication between the GPU (ARM) and the video component or video switch (730). In an embodiment of the invention the GPU (ARM) selects whether the data comes from the GPU (ARM) or from an external source.

In an embodiment of the invention one of the control busses is an SPI bus and in particular such bus is chosen for (bidirectional) communication between the GPU (ARM) (e.g. for setting of audio parameters by the GPU in the DSP and for read back of sound levels from DSP to GPU for further display on the GUI) and the DSP and/or between the GPU (ARM) and the microcontrollers.

In an embodiment of the invention bi-directional data (audio) communication (preferably stereo quality) is foreseen between GPU and DSP to enable execution of a audio player on the GPU while routing it via the DSP to any wanted audio output while enabling also recording via the GPU audio received via the DSP.

In an embodiment of the invention communication between GPU and the display, preferably a touch screen, is organized by use of a LVDS signal. In a preferred embodiment the touch screen sensor is connected to the GPU via another I2C bus to indicate the touch positions.

In an embodiment of the invention the front part of the display is foreseen with a proximity sensor. Such sensor is used for powering down the display after a pre-determined time and activating it when a user comes in the proximity of said sensor. This function contributes to further lowering the power consumption.

Generally speaking in an embodiment of the invention said electronic subsystem, comprises (i) a general purpose processor system (400), acting as central controller, (ii) a digital signal processor (710), under control of the general purpose processor via a first dedicated (SPI) bus, adapted for handling the audio signals and (iii) one or more microcontrollers (720), capable of generating, under control of the general purpose processor via a second dedicated (SPI) bus (different from said first dedicated bus), the synchronous signals (and hence having buffering capability) required for steering mechanical or lighting devices, (iv) a video switching component (730), under control of the general purpose processor via a third dedicated (I2C) bus and (v) said touchscreen communicates with said general purpose processor system via a fourth dedicated (LVDS) bus while its touch screen sensor communicates with said general purpose processor system via a fifth dedicated (I2C) bus (different from said third bus).

The use of a system in accordance with the invention ensure that in the meeting room wherein said system is installed at least the audio and/or video needs (further abbreviated AV) are easily controlled and this in one solution.

In embodiments of the system, you have instant access to Content and full control over its presentation, all on the same platform. Lighting, video and audio control are integrated and controlled on the same platform, making the system a cost effective, all-in-one solution.

AV needs are easily controlled by having and/or supporting the following:
an interface showing what you really need
wireless presentations
presentation files in internal memory
browse the web
meet with a minimum of disturbances
audio- and light levels at your fingertips
extensive audio facilities for optimum sound quality
record: make a recording of your meeting and save time
room scheduler: schedule a meeting on the panel or from your desk
robust design
low energy consumption
remotely mirror the systems user interface in a web browser
control your lighting (conventional and/or LED)

To complete your AV overall system, you only need speakers and a display to be connected to the invented system.

In accordance with an embodiment of the invention a touch interface is provided which is adapted such that it shows a view only showing what is really needed to operate the invented system.

The invented touch interface is purposely adapted to limit the information you need during meetings and presentations, not to distract you from the essential of having an efficient and successful meeting. The invented system and/or related touch interface has been designed with the comfort of the presenter in mind. Starting a presentation, a film or music, is very straightforward via the “guided” menu.

In a further embodiment the touch interface can be remotely mirrored to an external device, allowing control from anywhere in the room.

The systems allows for wireless presentations with your preferred laptop, tablet or smartphone.

Connecting to the meeting room's display or projector has become very much accessible. A presentation can be shown on screen instantly and people in the meeting are motivated for active participation.

To connect to the wireless presentations on the system, no extra hardware is required. Your device connects to system using your devices' built-in Airplay, Chromecast, Miracast technology. No apps are needed.

Common content presented in a meeting like company presentations, documents, photos, graphics . . . can be stored in and recalled from the internal memory of system. Content that is presented regularly—like company presentations—are instantly accessible.

The built in web browser allows for quick searches and sharing of information. Click on the browser and navigate to your required websites.

People entering the room—while a meeting is going on—can be disturbing. To avoid interruption, some activities like ordering beverages or a taxi, can be handled/supported (with) by the system. An automated mail message to a coworker will allow for the beverages to arrive. The focus stays on the meeting and disturbances are being minimized.

Simple control over audio volume and light levels is required at all times. Two faders situated at the left and right of the touch interface are accessible at all times, allowing for instant control.

The system has a built in audio mixer. Microphones, CD players and other sources can easily be connected.

Maximum listening experience is enhanced by a powerful DSP processor with multiple equalizer and limiting facilities. The integrated 2 channel 50 W amplifier completes the audio part. Only speakers have to be added to complete your system. Result is a crystal clear reproduction of your voice. Bluetooth allows for a wireless headset or a phone to be connected. The internal music player or internet radio allows for background music.

Don't lose time making notes, make an audio recording of your meetings. Archive your recordings for later consultation. The system is adapted to support such recordings.

In a further embodiment of the invention the system has the ability to control conventional room lights or even to select the color of LED lighting using a color wheel.

The room scheduler allows for planning of meetings and activities in an easy way. Gmail agenda integration show scheduled meetings anywhere.

In an embodiment the system is adapted to close the blinds and dim lights automatically while presenting.

Extensive automation features allow for events to be triggered on demand.

The aluminum casing of system ensures robustness with a modern design. The system is adapted for being desk or wall mounted.

Energy consumption is heavily reduced due to the systems complete electronic integration in its housing. The system is further adapted for operating silently.

In accordance with an exemplary embodiment of the invention the following technical specifications are found:

Audio

2 balanced mic/line inputs, +18 dBu

4 balanced line inputs, +18 dBu

6 balanced line outputs, +18 dBu

2 amplifier outputs 50 w/4 ohm each

Audio processing:

6×6 audio mix matrix

4-band parametric EQ on each input

4-band parametric EQ, Xover, limiter on each output recording: 48 Khz/24 bit

Video

HDMI 1920×1080p HD output

HDMI input

Light

DMX 512 output

4 General purpose outputs

2 General purpose inputs

2 General purpose in/outputs switchable

Communication

WiFi 802.11 a/b/g/n 2.4/5 Ghz MIMO

Bluetooth 4.0/BLE

1 Gigabit ethernet port

1 RS232 (Tx/Rx) port

1 IR output port

1 USB host port

General

10.1″ capacitive, multitouch display

Quad core Cortex A9 processor

Proximity sensor

Ambient light sensor

Power: 24 Vdc, 6 A max

Having explained the functionality of the invented system and related aspects like the user console and its uses and describing a few (exemplary) embodiments of the invention, some particular features of the invention can now be further described.

The system comprises besides other electronic components such as an amplifier and/or wireless transmission components, a programmable processor, while still being a low energy system, realized by integrating all components, including the processor in one single housing, more preferably on one board.

In a preferred embodiment the system further comprises of one or more sensors.

The processor is adapted to execution one or more computer programs for controlling the other electronic components, signal processing of sensor signals and/or steering the operations of the user console.

In an exemplary embodiment of the invention a quad core ARM SoC executing Android as operating system is selected. In a further embodiment of the invention it is worth noting that on top of the standard LINUX part of Android a plurality of software drivers are added thereto for control of these electronic components (from the user interface) other than the processor.

More generally speaking, in the invention one or more processors suitable for mobile systems and/or battery power use are selected.

In an exemplary embodiment the system is adapted such that in idle conditions the complete processor system consumes 0.5 W while in full execution (HD playback mode) still only 1.5 W.

Besides the processor system, the LCD, its backlight, a class D audio amplifier and components for realizing analog audio in- and outputs and other I/O are provided in the system. One or more of these subsystems can be switched off in order to realize the low energy consumption requirement.

In an exemplary embodiment the relative position of the electronic components such as amplifiers, processors is optimized in that interference is minimized, in particular the switching mode amplifier and/or switching mode power supplies should not interfere with the analog audio part of the system.

In an exemplary embodiment the complete system consumes on average less than 20 W.

Within the system a single power supply component used for feeding all mentioned subsystems is provided, again contributing to the low energy consumption requirement.

Further due to the integration in a single housing no further off board communication channels requiring again energy consumption are necessary.

In an exemplary embodiment the system does not have nor needs a ventilator.

In an embodiment of the invention the housings has a width B, height H and thickness D is defined as follows: B 272 mm×H 177 mm×D 58 mm.

In an embodiment of the invention the touchscreen surface has a width B, height H as follows: B 223 mm×H 125 mm.

Practically the buttons realized on the touchscreen have a minimum size of 20×20 mm.

Practically the sliders realized on the touchscreen have a minimum size of 70 mm in width and a height of maximum the touchscreen surface height of 125 mm.

In a first basis view there are at least 3, preferably 6 buttons and at least 2 sliders, preferably with the minimum dimensions described above.

In a second expert view there are at least 3, preferably 6 buttons and at least more than 2 sliders, preferably with the minimum dimensions described above.

The above exemplary embodiment shows that when the at least three buttons are horizontally aligned (and for the 6 button embodiment preferably two rows of three buttons are used) next to the two sliders that then given the spacing in between them there is no room to have any further sliders for the second view, so this additional slides will have to overlap with one or more of the present buttons.

In an exemplary embodiment there might be one button related to starting audio, one button related to starting video and one button related to arranging the light conditions. The sliders are preferably used one for audio (loudness) and one for the light conditions (light strength). When activating the extra sliders of the second view for the audio and/or the light conditions individual components of those can be steered. For the audio this might for instance related to the amount of audio channels supported by the system. Additional buttons might relate to mechanical operations like closing of the shutters of a location (either all or individually).

Alternatively formulated the invention provides a system comprising a (programmable) controller capable of controlling (simultaneously) a plurality of devices including audio, video, data, lighting and/or motor or relay devices, said (programmable) controller being in communication with a touch screen, coupled in communicating relationship with said (programmable) controller, the touch screen displays screens of user interface features, said user interface features are usable to control said programmable controller and said plurality of devices, said (programmable) controller configured to store a user interface device configuration that specifies said user interface features of said screens of said touch screen, convert said user interface device configuration into a layout that substantially preserve said user interface features of said screens as they would be displayed to a user on said touch screen, wherein the (programmable) controller being within an enclosure configured for housing the touch screen, the touch screen being provided with user-selectable and user controllable functionalities distributed over multiple levels in a control hierarchy, the touch screen comprising a display for displaying a graphical user interface (GUI), the controller being provided for enabling the user to control the devices through the GUI wherein the GUI provides a respective layout for each respective one of multiple control levels, each respective layout provide in a respective first area of the display first graphical representations of functionalities are provided selectable at the respective level; and each respective layout provide in a respective second area of the display second graphical representations of functionalities for a selection of functionalities, wherein in a first layout said first and second area does not overlap while in a second layout said first and second area does overlap.

To realize the invented system careful technical considerations have been made in that the required context (small system) requires design choices such as the single housing/one board integration. Further the same required context provided further design challenges for the graphical user interface, especially when on top of the small single housing the user console is realized as touchscreen. Moreover the required support of such touchscreen by a programmable processor further sets deliberate requirements on the processor system in terms of energy consumption. Further the low noise requirement, demanding a no ventilator approach, sets further requirements on the entire system in terms of energy consumption for instance by providing the on/off switching functionality. The invention combines all these considerations and challenges for a specific system capable of simultaneously controlling a plurality of (audio, visual and/or mechanical and/or lighting) devices. Moreover the challenges are tackled in various quite different domains such as mechanical (screen on the housing), electronically (selection of components and integration) and computer programs for graphical user interfaces and for the programmable processor. Further the choices made in any of those domains have impact on the choices in the other domain.

Recall that the invention provides for a small audio/visual support system by providing a system, having all the required functions, being encapsulated in a single housing. Hence the invention provides for the use of a single system for a single location, wherein it supports the audio/visual demands.

A first particular use is for meeting rooms, but the invention is not limited thereto. On the contrary it is an aspect of the invention to provide a re-useable hardware platform for use for other contexts by enabling software adaptions on application level and ensuring that such software adaptations are sufficient therefore. Therefore other uses like in pubs, restaurants, stores etc are equally possible. The invention is adapted to ensure that the user will have the ability to control its audio needs, but also to control its DMX enabled light fixtures and use the HDMI output to be used for digital signage/advertising. In an embodiment of the invention features present in the meeting room use are deliberately left out in the other use version. For instance the video streaming capability and/presentations menu are left out. As indicated the other use version will contain extra functionality such as: (i) more advanced DMX lighting controller which has more advanced programming techniques which is required in a pub environment; and/or (ii the ability to start a powerpoint style presentation and let it run on the background (for advertising use on a Tv set/projector in a pub or restaurant) and/or (iii) the ability to start a video file and let it run repeat mode (for advertising use on a Tv set/projector in a pub or restaurant).

Advanced DMX Light Controller

In a pub situation, the user wants to control its light fixtures from the AV panel and start/stop ‘cues’. These cues are programs which are programmed by the user/installer to start certain movement and/or color chases of the light fixtures. Below is more information which fixtures there are commonly used and how these need to be controlled. All values are represented between 0-255 (8 bit)

Common definitions:

Pan: controls the horizontal position of a moving head.

Tilt: controls the vertical position of a moving head.

Color wheel: an internal wheel of a moving head which can be rotated to move a certain color filter before the lens.

Gobo wheel: an internal wheel of a moving head which can be rotated to move a certain stencil before the lens.

Shutter: an internal plate which closes the light output of a moving head.

Dimmer: can dim the light output for the fixture.

DMX Fixtures

In an embodiment of the invented controller one can set any of the 16 fixtures to be Intelligent or a Generic dimmer. If it is intelligent, we can assign channels which the customer finds in the fixture datasheet to a corresponding function. Some will have a lot of functions, some only pan/tilt/dimming. For functions which the fixture doesn't have, we just set the channel to ‘none’.

If it is a dimmer, we have only 8 dimmer channels available which we can rename for ease of use.

Intelligent Fixture

Moving lights are the most complex object. When 4 fixture are used, then each fixture is set to its own start address. When for example the fixture has 20 channels, the first fixture is set to DMX address 1, the second on 21, the third on 41 and the fourth on 61.

All “moving head” types of fixtures have the same basic controls, but depending on the type it can have 1 or 2 color wheels, 1 or 2 gobo wheels, some types have a DMX channel to rotate the gobo itself.

Generic Dimmer Fixture

When we set the fixture type to ‘dimmer’, the lighting controller is actually informed that this fixture is multichannel dimmer.

Basic Operation

As there is no standard way of controlling an intelligent light, an important function for the light controller is to consolidate the various ways in which the hundreds of types of intelligent lights are controlled into a single abstract interface for the user. By integrating knowledge of different fixtures and their attributes into the lighting controller, the detail of how an attribute such as pan or tilt is controlled for one device vs. another can be hidden from the operator. This frees the operator to think in terms of what they want to achieve (e.g. pan 30 degrees clockwise) instead of how it is achieved for any given fixture (e.g. send value 137 down channel 23). In a certain CUE, not the actual DMX channel slot is stored, but functions of the selected fixtures with its value are stored.

First Step—Set Up Fixtures

Before the user can start using and programming the light controller, the user has to set-up the light fixtures which are going to be controlled. This is because the light controller has to know for example in a case of a ‘moving head’ fixture, which channels are assigned to pan/tilt/gobo/shutter etc.

In programming mode press the ‘edit fixture’ button and set your fixtures features and start address.

Second Step—Program the Cues

After the fixtures which the user wants to use are set-up, he can start programming the CUES.

In program mode and with ‘edit CUE’ selected he can press a certain cue button which brings him in the ‘edit CUE’ window of that corresponding CUE.

Example: he selects fixture 1, 2, 3 and 4 simultaneously and moves their beam using the pan/tilt control to a certain place. Then he set ‘step 2’ to ON and highlights step 2 selection button. He then unselects fixture 1 and 3 and in that way he can move fixture 2 and 4 to another position using the pan/tilt settings. When the sequence is run, the sequences go from step to step with an interval. The sequences keep running, so it goes step 1, 2, 1, 2

Third Step—Set Effect Generator Presets if Needed

So CUE 1 has something stored and we are back in the main window. We can press ‘CUE 1’ button to and make it run. Now we can add additionally an effects generator. In program mode, we press the Edit FX gen button. Then when we press ‘FX 1’, we will go to the effects generator preset window. Here we can select a circle function left or right running, a figure eight or linear. Also its size/speed etc can be selected. This Pan/tilt effects generator will run on top of everything and adds its values with the pan/tilt values on one moment of time.

Edit Cues in Detail

What is stored in a CUE? In short, all settings for each step and all function values of the selected fixtures of each step.

Example:

Step 1: Fixture 1, 2, 3, 4 are selected

Step 2: Fixture 1, 3 are selected (user wants to change only functions of fixture 1, 3 and leave 2, 4 as they were in previous step)

Step 3: Fixture 2, 4 are selected (user wants to change only functions of fixture 2, 4 and leave 1, 3 as they were in previous step)

The result is that all fixture settings from fixture 1, 2, 3, 4 are stored in the CUE!

Effects Generator in Detail

In an embodiment of the invention a single effects generator is used, which technically are two 16 bit waveform generators in sync which creates a certain pattern on the selected fixtures.

Sine generator 1 MSB is assigned to PAN, the LSB is assigned to PAN FINE

Sine generator 2 MSB is assigned to TILT, the LSB is assigned to TILT FINE

Circle →: Pan sine, Tilt Cosine

Circle ←: Pan Cosine, Tilt sine

Linear: Pan linear, Tilt linear

Figure eight: Pan linear, Tilt sine

The speed knob controls both waveform generators simultaneously, but there are two knobs to set the size of each waveform generator between 0 and max.

Offset by: ‘none’ means that all selected fixtures have 0 degree phase difference. ‘by fixture’ means that—if you selected 4 fixtures—each fixture has a 90 degree phase difference.

In an embodiment of the invention this waveform generator is kept running in the background, so that switching between one of the 6 buttons only changes value of the waveforms. In this way there is a smooth transition when choosing another ‘preset’ buttons'. The OFF button can make the waveforms generator stop completely.

Main Button Press Window in Detail

What about toggling/flash cues and effect generator preset buttons?

CUE buttons: CUE buttons toggle between cues which are in a certain CUE group. (this is set for every cue in the cue edit window)

Example: you have set CUE 1, 2, 3 to CUE group 1 and you have set CUE 4, 5, 6 to CUE group 2. Now you can toggle between CUE 1, 2, 3. CUE 4, 5, 6 are in another CUE group, so they toggle separately between them.

Example 2: you have set CUE 1, 2, 3 to CUE group 1. CUE 1, 2 are set to ‘toggle mode’ and CUE 3 is set to ‘flash mode’. When CUE 2 is running and you press CUE 3, it will run CUE 3 as long as you press it and when you releaser the button it goes back to the last CUE in this group (CUE 2).

Effects generator buttons: These toggle between the six buttons

Edit Fixture in Detail

When we want to set-up our fixtures, we first choose which type (intelligent or dimmer).

If intelligent, we can set the channel for each function of the fixture. If dimmer type: It will show only a ‘dimmer’ tab with eight dimmer scrollwheels which you can rename.

For each fixture you need to set its start address. This is done for ease of use. The datasheet of the fixture says that PAN is ch 1, TILT is ch 2 etc. When you set the start address to 101, the PAN value will be send on DMX channel slot 101 and TILT on DMX channel slot 102.

As indicated above also the uses for control of light fixtures and/or use an output to be used for digital signage/advertising poses a challenge in particular on the software (GUI) supporting it. Again the GUI should support different views such as live mode view and/or program mode view. Between those one should be able to switch easily. From the program mode one can go to still further views such as several edit views. The GUI views have a few fixed sliders for audio and light control in common. In a particular embodiment the GUI is adapted to handle (use (in live mode), program or edit (in one or more of the program or edit views) programs which are programmed by the user/installer to start certain movement and/or color chases of the light fixtures. In a further embodiment also so-called effects generator are provided, which are two waveform generators which can be used to create a certain pattern on the selected fixtures. Also these effect generators can be programmed or edited. In a further embodiment (combinable with the other embodiments) programming, editing or setting characteristics of adapted or intelligent light fixtures is foreseen.

In summary the invention provides for a system (capable of)/for controlling a plurality of (audio, visual and/or mechanical and/or lighting) devices in a location, the system comprising/consisting (1) a housing comprising an electronic subsystem (controller) for generating (all) control signals for (all) said devices and input/output connectors for providing the generated control signals to said devices; and (2) a touchscreen console (being in communication with said electronic subsystem), (solely) used (and hence not for receiving other visual info) for (and being the sole physical way for) (hence no additional buttons being present, in an embodiment a further external web browser access is provided) steering the operations of said electronic subsystem; whereby said touchscreen console, being provided on said housing.

1. A system for controlling a plurality of devices in a location, of which at least one of said devices is an audio device, at least one of said devices is a video device and at least one of said devices is one other than an audio or video device, the system comprising (1) a housing comprising (a) an electronic subsystem for generating control signals for said devices and (b) suitable input/output connectors for providing the generated control signals to said devices; and (2) a touchscreen console, being in communication with said electronic subsystem, used for steering the operations of said electronic subsystem; whereby said touchscreen console is provided on said housing.

2. The system of claim 1, wherein said electronic subsystem, comprises (i) a general purpose processor system, acting as central controller, (ii) a digital signal processor, under control of the general purpose processor, adapted for handling the audio signals and (iii) one or more microcontrollers, capable of generating, under control of the general purpose processor, the synchronous signals required for steering mechanical or lighting devices.

3. The system of claim 2, wherein said digital signal processor is capable of implementing an audio matrix functionality.

4. The system of claim 2, wherein said electronic subsystem further comprises a video switching component, under control of the general purpose processor.

5. The system of claim 2 wherein said digital signal processor is under control of the general purpose processor via a first dedicated bus, said one or more microcontrollers are under control of the general purpose processor via a second dedicated bus, said video switching component is under control of the general purpose processor via a third dedicated bus and said touchscreen communicates with said general purpose processor system via a fourth dedicated bus while its touch screen sensor communicates with said general purpose processor system via a fifth dedicated bus.

6. The system of claim 2, wherein the touchscreen is configured (1) for providing a first display dedicated for first users and (2) for providing on request a second display dedicated for second users of one or more of said plurality of devices.

7. The system of claim 6, wherein said second display when activated at least overlaps in part with said first display.

8. The system of claim 2, wherein the touchscreen is configured (1) for providing a first display dedicated for enabling a user to select programs and/or effects to control at least one lighting device and (2) for providing on request a second display dedicated for enabling a user to create/adapt such programs and/or effects.

9. The system of claim 2, wherein the overall energy consumption is limited to 20 Watt.

10. The system of claim 2, wherein the system comprises a processor system and other electronic components, integrated on one board, wherein the ratio of energy consumption of said processor system over the overall energy consumption is less than 0.2.

11. The system of claim 10, wherein the system is adapted for switching off one or more of said other electronic components.

12. The system of claim 10, wherein the 2D location of said electronic components being selected to minimize interference.

13. The system of claim 1, wherein the housing comprises input/output connectors for providing the generated control signals to said devices, the housing being placed on a support and wherein a plurality of said input/output connectors being provided of the side of said housing directed to said support.

14. The system of claim 13, wherein from said plurality of said input/output connectors at least two are placed on top of each other in the direction of the depth of said housing and the housing is locally adapted for such purpose.

15. A computer program product comprising computer-readable code that, when run on a system in accordance with claim 1, causes the computer system to support a graphical user interface on the touchscreen of the system.
